(19) United States
(12) Patent Application Publication
(10) Pub. No.: US 2009/0106143 A1
(43) Pub. Date: Apr. 23, 2009

(54) Payment processing system

(76) Inventors: Jonathan Gustave, Tenafly, NJ (US); Gary Lazarus, Millwood, NY (US)

Correspondence Address: LEVISOHN, BERGER , LLP, 61 BROADWAY , 32ND FLOOR, NEW YORK, NY, 10022, US

(21) Appl. No.: 11/657,991

(22) Filed: Jan. 25, 2007

(51) Int. Cl. G06Q 40/00

(52) U.S. Cl. 705/39

(57) ABSTRACT

A payment processing system wherein payment data is entered into a database on a server. The server is accessible to clients via a Web page on the Internet. Clients, by selecting search parameters on the Web page, can comprehensively search payment activity from the time a payment is initiated, until and including, the time a payee's account is credited. Clients, and/or their back-offices receive active updates of payment status information.

### FIELD OF THE INVENTION

The present invention relates to the field of processing payments, specifically to an automated method of processing checks, money orders, wire transfers, credit card payments, periodic account debiting, electronic checks and similar payments along with associated account information.

### BACKGROUND OF THE INVENTION

The tender of a payment, by the any of the methods identified above, such as by paper bank check, or an electronic form thereof, are common forms of payment for a variety of goods and services. For example, checks are routinely remitted for the payment of rental or leased property, mortgages, insurance policies, and medical payments. Credit cards used for the payment of certain one-time, or recurring bills, such as cable rent or the like may be debited against a payor for a payee. In the most basic level, a paper check is conveyed to an obligee as a payment for a good or service. The payee receiving the payment then endorses the check and deposits it in a bank account. In some cases payees receive many checks on a monthly, weekly, or even daily basis. However, the processing of checks, or of other payment methodologies, is very expensive, involving human intervention and attention, in addition to undesired errors which must be resolved.

For each of the checks received, the accuracy of certain information must be verified. For instance, was the check written for the correct amount of money, is it signed, and is it associated with a correct customer account information? As an example, a real estate management company which receives a large number of checks for the payment of rents and maintenance fees bears enormous transaction costs in processing the checks that it receives.

To minimize the transaction costs associated with its processing, many automated or semi-automated processes have been designed for the bulk processing of payments. However, many of the systems used in the prior art lack efficiency and speed. In the example of a real estate management company, the company might have certain requirements, standards or restrictions in place for the acceptance and/or rejection of payments. For instance, the company may have a policy that it will not accept checks that are not for the full amount due. They might additionally, or alternatively, have a policy that the name that appears on the check must match the name of the holder of the account. For the purposes of this application, all of these policies are called “Rules.” When a Rule is not followed an “Exception” to the Rule occurs. A major issue in any automated system is how to deal with Exceptions. In the current state of the art, a great deal of manual, human intervention is required to resolve these Exceptions. This ultimately leads to reduced efficiency, higher costs and delayed payments.

Another issue that must be addressed in designing an automated processing system is the accessibility of transaction status information by clients. To that end, the ability for a client to run searches in order to track prior or pending transactions is an important feature of such a system. The searching parameters as well as the search duration of prior systems is highly restrictive. More advanced searching capabilities is therefore of high importance in designing a new automated processing system.

### DESCRIPTION OF THE INVENTION

An automated process for handling bulk payments is contemplated which is highly efficient and provides a platform for clients to customize their particular needs. The system features highly advanced searching capabilities, which allows the system to initiate searches that will run during the pendency the revenue recognition cycle. For the purposes of this patent application, the term “revenue recognition cycle” shall be used to designate the process from when a payment is first initiated, such as a check being received or an electronic payment being initiated, until and including, the time an amount is credited to the payee's account or accounts. Searches can be run at specified intervals, for example, through the night, or even nightly, whereby the client is notified about desired status information.

An object of this invention is to enable payees to easily and efficiently access information on the system.

Another object of this invention is to provide information during the running of the revenue recognition cycle that is important to users of the system in order that they are alerted to or want to query certain occurrences in the process.

Still another object of this invention is to reduce the cost of handling transactions, in addition to accelerate the receipt of payments into the payee's account.

Other objects, advantages and features of this invention will become apparent from the following description.

As a preferred embodiment, the present invention provides an interactive website, whereby a client can search prior and/or pending transactions using multiple criteria and/or search terms. In an embodiment of the invention, a client who is waiting for a particular transaction to occur, may initiate a search wherein he will be notified through an Internet webpage when that transaction has occurred. In this embodiment, the website provides fields wherein query information may be entered. For example, the website may contain a drop-down menu, from which a client may select to search by one or more search parameters such as, check amount, check number, account number, minimum or maximum payment amount, or any combination thereof. In another embodiment, the website further provides a field in which a client can furnish an e-mail address. The website additionally allows a client to specify at which times the searches should be run. For instance, a client may select a nightly search to be run for a payment on a particular account. The search engine will conduct those searches nightly until the transaction is located, at which time the webpage is updated to show the search results and/or an e-mail may be sent to the client's e-mail address which he has provided to the website indicating that his search results have been posted online. Alternatively, an e-mail may be sent directly to the customer apprising him of any search results. Obviously, so as to protect the confidentiality of such information, e-mails will only be sent via a secured communication channel whereby such information is adequately safeguarded. In another embodiment, search results can be communicated to a customer's designated telephone number over a secure line.

The present invention provides automatic notification to customers or can respond to customer inquiries. It may be understood that in the prior art, payees would not know what the status of the revenue recognition cycle might be, because the payee would only be notified when the payment hits the account. The present invention permits access by a customer as the cycle is being run, allowing for more specific information which the customer needs and wants immediately. As an example, “the check is in the mail” can now be verified by this system. Additionally, a client's back-office can be actively updated with any payment advice.

### BRIEF DESCRIPTION OF THE DRAWINGS

FIG. 1 is a block diagram of a payment processing system consistent with an embodiment of this invention.

FIG. 2 is a screen shot, wherein a search query may be initiated, consistent with an embodiment of the current invention.

FIG. 3 is a screen shot, wherein an additional search may be initiated, consistent with an embodiment of the current invention.

FIG. 4 is a screen shot, wherein additional parameters may be added to a search, consistent with an embodiment of the current invention.

FIG. 5 is a screen shot, wherein search results are displayed, consistent with an embodiment of the current invention.

FIG. 6 is a screen shot, wherein a query is created for future use, consistent with an embodiment of the current invention.

FIG. 7 is a screen shot, wherein a query is deleted, consistent with an embodiment of the current invention.

Embodiments of the present invention, which have been described above, will now be further described with reference to the above-identified figures of the Drawings. However, the Drawings and the description herein of the invention are not intended to limit the scope of the invention. It will be understood that various modifications of the present description of the invention are possible without departing from the spirit of the invention. Also, features described herein may be omitted, additional features may be included, and/or features described herein may be combined in a manner different from the specific combinations recited herein, all without departing from the spirit of the invention.

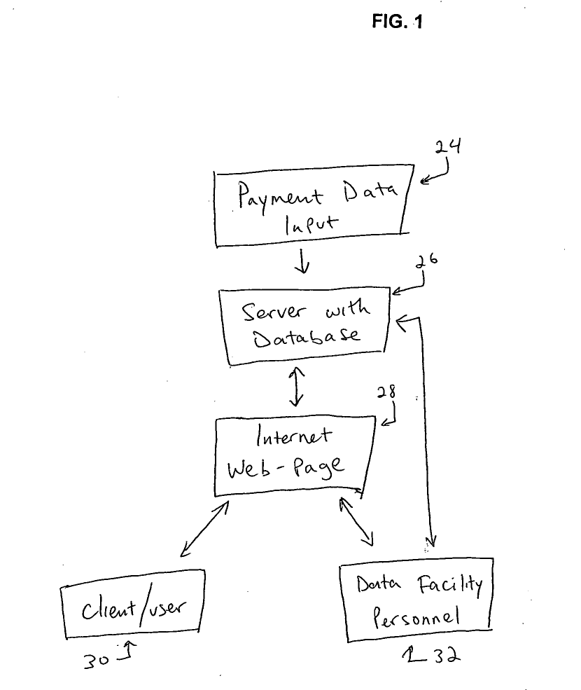

The current invention—which is directed to implementing searching capabilities that allow a user to search and/or monitor account activity at any point during a revenue recognition cycle—combines many advances in scanning technology, specialized recognition engines, computer software, the Internet and hypertext enabled Web pages. Referring to FIG. 1, in an initial step, payment data 24 is entered into a database 26. As an example, such data may be in the form of a bank account number or a credit card number. In one embodiment, a data processing facility stores the bank account or credit card numbers, and initializes payments to be made from those accounts on a designated schedule. In another embodiment, the processing facility receives paper checks to be deposited at specified banks. In this embodiment, paper checks are scanned, for example using an Opex 3690 scanner. An image recognition engine such as A21A's CAR/LAR image recognition engine is programmed to read data fields and store them in column form on a database located on a server 26. In a preferred embodiment, the system is run in a Microsoft.net environment with a sequel server database. The database is searched using specially programmed software. The software used to generate searches is accessible and controllable via a Web page 28 on the Internet. As such, a user 30 who is logged into the Internet can generate searches of the database. In a further embodiment, search parameters can be stored on a server 26. Based upon these stored parameters, the search software, or search engine can be programmed to run searches at specified intervals. The computer software finds specified entries in the database based upon specific search parameters, tabulates the data and displays them on a Web page 28. Personnel of the processing facility 32 access the server containing the database 26, either directly or through the Internet 28. Such computer software for conducting searches of the database is conventional to those of ordinary skill in the art.

In an embodiment of the current invention, a user who wants to receive active notification of the status of a payment or an expected payment is automatically notified of such information rather than continually polling the system to discover the same information. In a preferred embodiment, a user can be notified of account activity at any point during a revenue cycle, spanning from the time of sending or initiating a payment, until and including, the time that the payment is made.

The Advanced Lockbox Search embodiment of this invention allows members to conduct searches using multiple criteria with logical operators such as greater than, less than, equal to, starts with, and contains. An additional feature of the system is the ability to save searches to run again at a later time. Searches can also be scheduled to run automatically each night and notify the member via email when a match is found. For example, if you created a search to look for a payment with a specific account number, you would be notified the night it was processed.

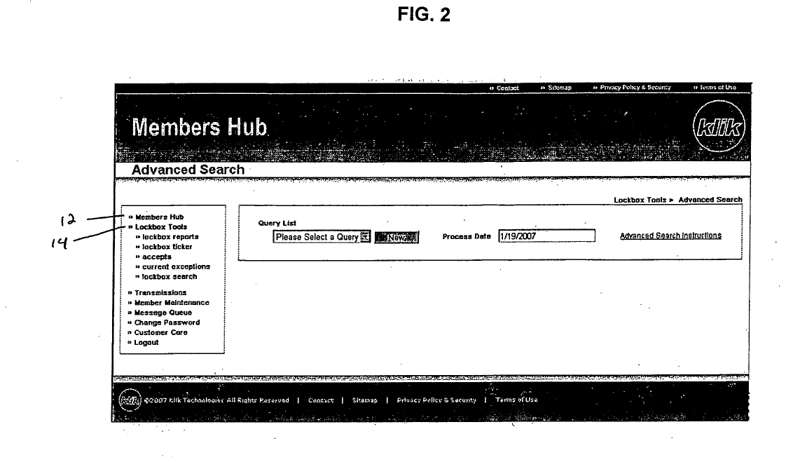

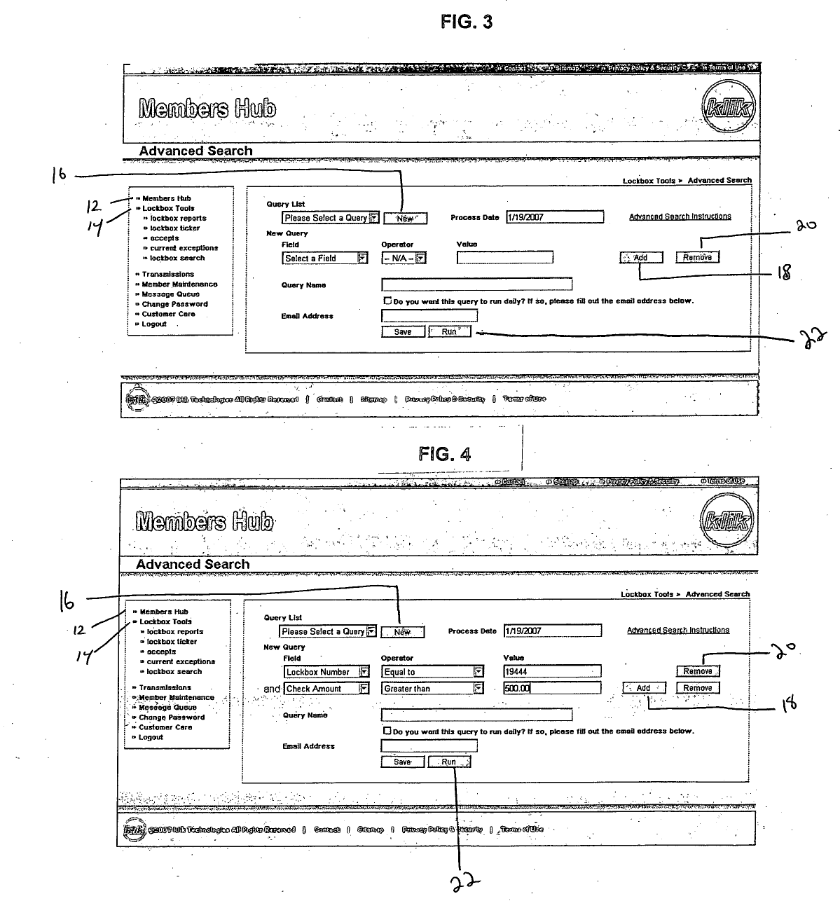

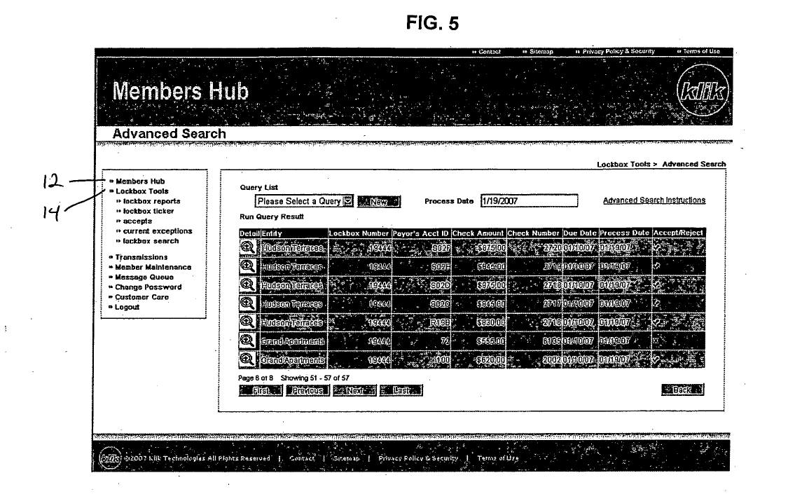

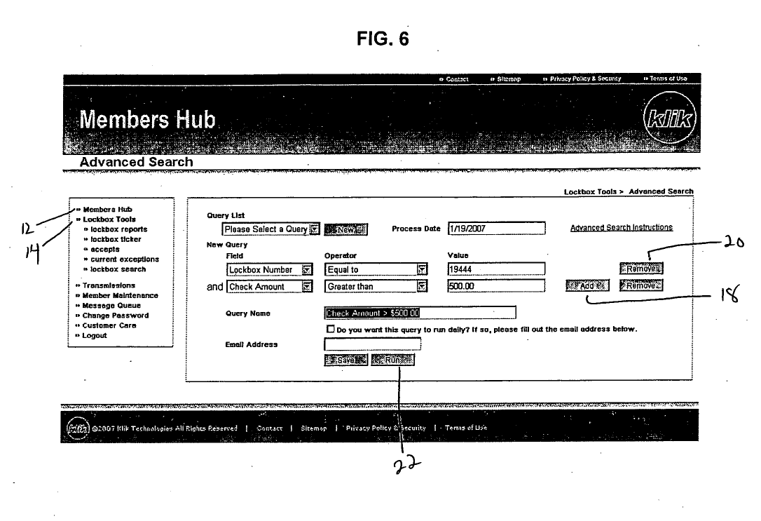

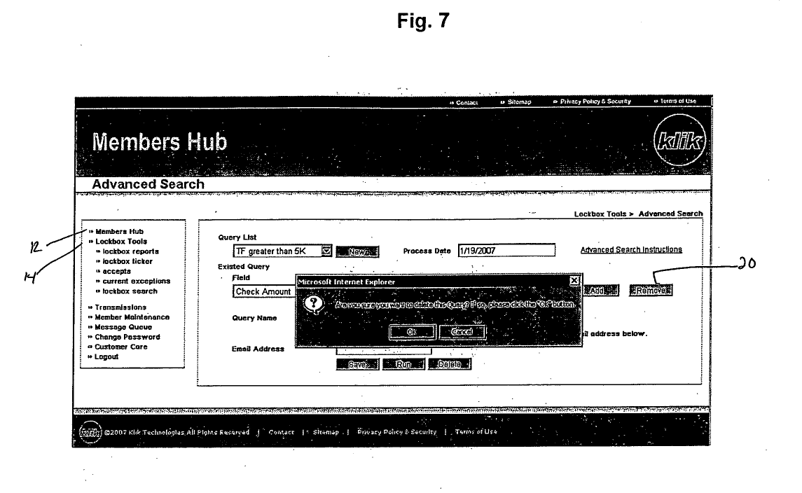

FIGS. 2-7 present different screens which are available to a payee, and are the vehicles with which the various search features of this invention may be initiated.

To create a one-time query, users of the company's website may go to the Members Hub 12, select Lockbox Tools 14, and then select Advanced Search. If a user would like to initiate a new search, he may do so by clicking on the New icon 16.

Additional parameters may be added to an existing search by clicking the Add icon 18. Alternatively, parameters may be removed by clicking on the Remove icon 20. Once the desired parameters are selected, a user may click on the Run icon 22 and retrieve search results tabulated on a Web page (FIG. 4).

In another embodiment a user may be set up a query to be initiated at a future time. In this embodiment the user enters query information into a field for Query Name 24. The user then indicates, by filling in a specific field or selecting from a menu at which times he wants the query to run. For example, a user may choose to run a query each evening until his results are found.

In another embodiment, a user provides an e-mail address, for example, by entering it into a designated field on a Web page 26. In this embodiment, a user will be notified via e-mail that search results have been posted on the Web.

Having described this invention with regard to specific embodiments, it is to be understood that the description is not meant as a limitation since further modifications and variations may be apparent or may suggest themselves to those skilled in the art. It is intended that the present application cover all such modifications and variation as fall within the scope of the appended claims.

What is claimed is:

1. A payment processing system in which payments are processed and are remitted to at least one payee in the course of a revenue recognition cycle, said payments comprising a payor's account information to be debited, said payment processing system comprising:
a computer to receive said account information to be entered into predetermined data fields in a database,
said processing system being computer run on at least a server, said server being accessible by the Internet to said payee,
said processing system creating status information on the processing of payments,
wherein a payee is enabled to receive status information from said server and being informed as to status information while said revenue recognition cycle is proceeding, said payee thereby being aware of the payment process before payment is finally credited to payee's account.

2. The processing system of claim 1, wherein said payee is informed as to when said payments are expected to be deposited in payee's account.

3. The processing system of claim 1, wherein said system initiates communication with the payee on the status of the processing of a payment.

4. The processing system of claim 3, wherein said system notifies the payee when a specified payment will be credited to payee's account.

5. The processing system of claim 3, wherein said communication is via the Internet.

6. The processing system of claim 3, wherein said communication is transmitted to payee's designated telephone number over a secure line.

7. The processing system of claim 1, wherein said server comprises an interactive website, wherein said payee is connected to said website and initiates a desired search through selected parameters as controlled by the payee.

8. The processing system of claim 7, wherein said website comprises a menu comprising a plurality of search parameters selectable by said payee.

9. The processing system of claim 1, wherein said processing system automatically queries for a payee's desired information at periodic intervals.

10. The processing system of claim 9, wherein said periodic intervals are during the time said payee is normally sleeping.

11. The processing system of claim 7, wherein said system initiates communication with the payee on the status of the processing of a payment.

12. The processing system of claim 7, wherein said communication is via the Internet.

13. The processing system of claim 7, wherein said communication is transmitted to payee's designated e-mail address.
